(19) United States
(12) Patent Application Publication
(10) Pub. No.: US 2026/0237730 A1
(43) Pub. Date: Aug. 13, 2026

(54) PROCESS FOR PRODUCING A SOLID ELECTROLYTE MATERIAL HAVING A LOW CARBON CONTENT

(71) Applicant: Solid Power Operating, Inc., Louisville, CO (US)

(72) Inventors: Clint R. BICKMORE, Louisville, CO (US); Brian E. Francisco, Arvada, CO (US)

(21) Appl. No.: 19/088,579

(22) Filed: Mar. 24, 2025

Related U.S. Application Data
(60) Provisional application No. 63/568,666, filed on Mar. 22, 2024.
(60) Provisional application No. 63/637,801, filed on Apr. 23, 2024.

(51) Int. Cl. H01M 10/0562; H01M 10/0525

(52) U.S. Cl. CPC H01M 10/0562; H01M 10/0525; H01M 2300/0068

(57) ABSTRACT

Processes for producing sulfide-based solid electrolytes include contacting solid electrolyte precursors with molten sulfur. The resulting sulfide-based solid electrolyte has a low carbon content and large particle size. The solid electrolyte includes a crystalline phase, an amorphous phase, or a combination thereof.

### CROSS-REFERENCE TO RELATED APPLICATION

This application is related to and claims priority under 35 U.S.C. § 119(e) to U.S. Patent Application No. 63/637,801, filed Apr. 23, 2024, titled “PROCESS FOR PRODUCING A SOLID ELECTROLYTE MATERIAL HAVING A LOW CARBON CONTENT,” and to U.S. Patent Application No. 63/568,666, filed Mar. 22, 2024, titled “SOLID ELECTROLYTE PRODUCTION PROCESS USING CARBON-FREE-LIQUID,” both of which are hereby incorporated by reference in their entirety.

### BACKGROUND AND INTRODUCTION

Lithium-ion batteries are everywhere. The current generation of batteries use liquid electrolytes allowing lithium ions to move between the electrodes. However, batteries that use liquid electrolytes have a safety issue due to the liquid electrolyte being flammable, and the batteries being used in applications where the battery may be damaged resulting in the exposure of the liquid electrolyte. To make these batteries safer, the liquid electrolyte may be replaced with a solid electrolyte material in a type of battery referred to as a solid-state battery. Solid-state batteries provide other possible improvements over other batteries including higher energy density, faster charging and increased lifespan.

As the demand for batteries that contain these solid electrolytes becomes more prevalent, the production of these solid electrolyte materials must be increased. Traditionally, to make solid electrolyte materials, solid electrolyte precursors are mixed with highly flammable carbon-based solvents where the solvents are later removed. Using these flammable solvents during the production process adds complexity to the process among other concerns. Additionally, these solvents may degrade the electrolyte material or cause a buildup of unwanted impurities to occur. These carbon-based solvents may also introduce water into the mixture, where even less than 100 ppm water can cause unwanted side reactions to occur. Ultimately these solvents require waste handling processes for disposal and reuse, and these extra processes increase the cost of using petroleum-based solvents.

It is with these observations in mind, among others, that various aspects of the present disclosure were conceived.

### SUMMARY

In an embodiment, a process for making a sulfide-based solid composite including a sulfide-based solid electrolyte comprises contacting a solid electrolyte precursor with molten elemental sulfur at a temperature of about 100° C. or greater to form a sulfide-based composite. In some embodiments, the contacting step of the process may further comprise mixing or milling the solid electrolyte precursor with the molten elemental sulfur.

In another embodiment, the solid electrolyte precursor comprises lithium, phosphorous, sulfur, or a combination thereof.

In another embodiment, the solid electrolyte precursor comprises lithium metal, Li₂S, Li₂SO₄, LiOH, Li₂CO₃, or a combination thereof.

In another embodiment, the solid electrolyte precursor comprises elemental phosphorous, P₄S₁₀ (P₂S₅), P₄S₉, P₄S₇, P₄S₃, P₄Sₓ wherein X>10, or a combination thereof.

In another embodiment, the solid electrolyte precursor comprises Na₂Sₓ, K₂Sₓ, Li₂Sₓ wherein 1≤X≤8, NaSH, LiSH, or a combination thereof.

In another embodiment the solid electrolyte precursor comprises LiF, LiCl, LiBr, LiI, LiClₓBr_{y} wherein 0<x<1, 0<y<1, and x+y=1, or a combination thereof.

In another embodiment, the solid electrolyte precursor comprises a halogen-containing material comprising F, Cl, Br, I, or a combination thereof.

In another embodiment, the process for making a sulfide-based solid composite including a sulfide-based solid electrolyte comprises contacting the solid electrolyte precursor with molten elemental sulfur at a temperature from about 100° C. to about 300° C.

In another embodiment, the process for making a sulfide-based solid composite including a sulfide-based solid electrolyte comprises contacting the solid electrolyte precursor with molten elemental sulfur for a period of time from about 1 minute to about 36 hours.

In another embodiment, the process for making a sulfide-based solid composite including a sulfide-based solid electrolyte further comprises separating at least 90% of the elemental sulfur from the sulfide-based solid composite by evaporation, filtration, centrifuge, or a combination thereof.

In another embodiment, the process for making a sulfide-based solid composite including a sulfide-based solid electrolyte further comprises heating the sulfide-based solid composite to a temperature greater than about 300° C.

In another embodiment, the process for making a sulfide-based solid composite including a sulfide-based solid electrolyte further comprises heating the sulfide-based solid composite to a temperature greater than about 300° C. for a period of time from about 1 minute to about 36 hours to form a sulfide based solid electrolyte. The sulfide-based solid electrolyte may have the formula Li_{(7-y-z)}PS_{(6-y-z)}X_{y}W_{z}, wherein X and W are individually selected from F, Cl, Br, and I; 0≤y≤2; 0≤z≤2; and 0≤y+z≤2. As another example, the sulfide-based solid electrolyte may have the formula Li₂P₂S₆, Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, or Li₅PS₄ClBr.

In another embodiment, the molten elemental sulfur is present in an amount from about 10 wt % to 75 wt % of the combined mass of the molten elemental sulfur and the solid electrolyte precursor.

In another embodiment, a sulfide-based solid electrolyte comprises lithium and sulfur having a particle size greater than about 0.5 μm. The sulfide-based solid electrolyte is produced by contacting a solid electrolyte precursor with molten elemental sulfur at a temperature greater from about 100° C. and to about 300° C. for a period of time from about 1 minute to about 36 hours to produce a sulfide-based solid composite, separating at least 90% of the molten elemental sulfur from the sulfide-based solid composite, and heating the sulfide-based solid composite to a temperature of greater than about 300° C. for a period of time from about 1 minute to about 36 hours.

In another embodiment, the sulfide-based solid electrolyte has a carbon content of about 1 wt % or less and a surface that contains less than about 0.5 wt % carbon.

In another embodiment, the sulfide-based solid electrolyte comprises a solid electrolyte material having the formula Li_{(7-y-z)}PS_{(6-y-z)}X_{y}W_{z}, wherein X and W are individually selected from F, Cl, Br, and I; y and z each individually range from 0 to 2; and wherein y+z ranges from 0 to 2.

In another embodiment, the sulfide-based solid electrolyte comprises a solid electrolyte material having the formula Li₂P₂S₆, Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, and Li₅PS₄ClBr.

In another embodiment, the sulfide-based solid electrolyte comprises an X-ray diffraction pattern having peaks corresponding to a 2-theta of 17.5°±0.5°, 18.1°±0.5°, 19.9°±0.5°, 22.8°±0.5°, 25.95°±0.5°, 29.1°±0.5°, 29.9°±0.5°, and 31.1°±0.5° with Cu—Kα(1,2)=1.541 Å.

In another embodiment, the sulfide-based solid electrolyte comprises lithium and sulfur having a particle size greater than 20 μm.

These and other aspects of the present disclosure are described further in the description that follows.

### BRIEF DESCRIPTION OF THE FIGURES

FIG. 1 shows a flow chart depicting the process flow of the disclosed process.

FIG. 2 shows a chart depicting the X-ray Diffraction Pattern (XRD) of the material produced in Example 1 and Example 2.

### DETAILED DESCRIPTION

Before aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

As used herein in the specification and claims, unless clearly indicated to the contrary, the indefinite articles “a” and “an” should be understood to mean “at least one.”

In this disclosure, the terms “including,” “containing,” and/or “having” are understood to mean comprising, and are open ended terms.

As used herein, the term “electrolyte” refers to a complete material suitable for use as the electrolyte in an electrochemical device. A “solid electrolyte” refers to an electrolyte in the solid state, which is suitable for use in the same state. The solid electrolyte or electrolyte may be a pure, i.e., a single component material, with respect to both chemical composition, crystalline structure, and atomic structure, or it may contain a mixture of components having different chemical compositions, crystalline structures, and/or atomic structures.

As used herein, the term “composite” refers to a mixture of at least two components having distinct chemical compositions, crystalline structures, and/or atomic structures.

As used herein, the term “compound” refers to a component defined by a single chemical composition and a single crystalline structure.

As used herein, the term “elemental sulfur” refers to atomic sulfur as well as known sulfur allotropes, including but not limited to S₈, S₇, S₆, and polymorphs thereof.

Described herein are processes for producing solid-state electrolyte materials having low carbon content. The processes may generally include contacting one or more solid electrolyte precursors with elemental sulfur in a molten state, rather than contacting the precursors with a hydrocarbon solvent, to form an electrolyte precursor slurry. The mixing may include griding, milling, or high energy shearing. The contacting occurs in a vessel suitable for containing the solid electrolyte precursors and elemental sulfur at high temperatures. The process may be performed using low temperatures and widely available materials. This produces a slurry of electrolyte precursors and, eventually, a solid-state electrolyte material that is devoid of any carbon residue or hydrocarbon solvent that may otherwise form or be left over when producing a solid-state electrolyte using a hydrocarbon solvent in a conventional technique. The processes may further include heating the electrolyte precursor slurry to remove the elemental sulfur, thereby forming the solid-state electrolyte. The processes and resulting solid-state electrolytes, are described in more detail below.

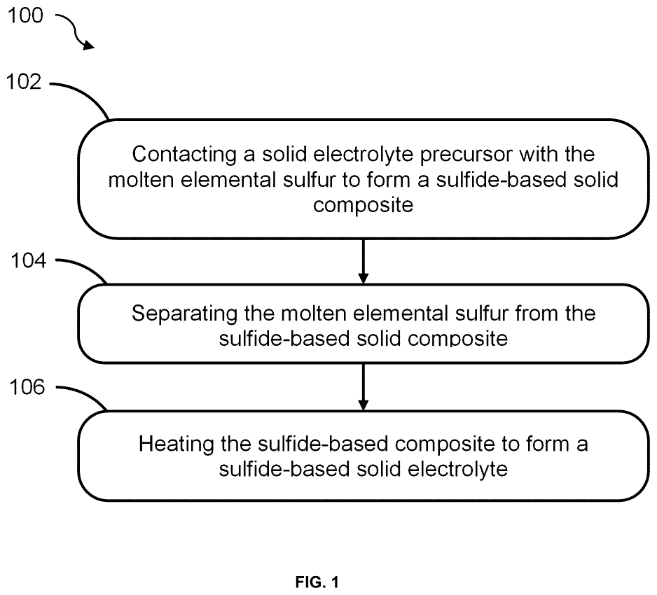

As depicted by FIG. 1, the first step 102 of the process 100 may include contacting at least one electrolyte precursor with molten elemental sulfur to produce an electrolyte precursor slurry. Contacting the at least one electrolyte precursor with molten elemental sulfur may be accomplished by mixing the solid electrolyte precursor and the molten elemental sulfur using agitation, grinding, milling, or high energy shearing. Those having ordinary skill in the art will understand that the contacting step may be performed multiple times depending on how many electrolyte precursors will be used to form the solid-state electrolyte.

The at least one solid electrolyte precursor may include a lithium-containing material, a phosphorus-containing material, a sulfur-containing material, a halogen-containing material, or any combination thereof. The lithium-containing precursor may include Li₂S, Li₂SO₄, LiOH, Li₂CO₃, an alkali halide comprising LiX (wherein X includes F, Cl, Br, or I, other lithium-containing precursors known in the art, or any combination thereof). The phosphorus-containing precursor may include P₂S₅, P₄S₁₀ (P₂S₅), P₄S₉, P₄S₇, P₄S₃, P₄Sₓ wherein X is greater than 10, other phosphorus-containing precursors known in the art, or any combination thereof. The sulfur-containing precursor may include Na₂Sₓ, K₂Sₓ, or Li₂Sₓ wherein 1≤X≤8, NaSH, LiSH, an alkali metal sulfide comprising A₂S where A includes Li or Na, SiS₂, Sb₂S₃, GeS₂, SnS₂, other sulfur-containing precursors known in the art, or any combination thereof. In some embodiments when the sulfur-containing precursor includes Na₂Sₓ, K₂Sₓ, or Li₂Sₓ, X may be 1<X<8; for example, X may be 2, 3, 4, 5, 6, or 7. The halogen-containing material may include LiF, LiCl, LiBr, LiI, LiClₓBr_{y} where 0<x<1, 0<y<1, and where x+y=1, other halogen-containing materials known in the art, or any combination thereof.

In some embodiments, one or more of the solid electrolyte precursors may be soluble in the molten sulfur. In other embodiments, one or more of the solid electrolyte precursors may react with the elemental sulfur forming one or more new materials. The new materials may be in a solid or liquid state and may react with one or more of the solid electrolyte precursors to form a new compound.

In one embodiment, sulfur-containing solid electrolyte precursors may be contacted with the molten sulfur. Upon contacting the sulfur-containing solid electrolyte precursors with the molten sulfur, those sulfur-containing solid electrolyte precursors may transition from having a crystalline structure to an amorphous structure. During this transition from crystalline to amorphous, the sulfur-containing electrolyte precursors may form one or more P-S chemical building blocks such as PS₄³⁻, P₂S₆⁴⁻, and P₂S₇⁴⁻, or a combination thereof.

The heat used to heat the molten sulfur and the solid electrolyte precursors may be generated from an external source, an internal source, or a combination thereof. To generate heat externally, heating devices such as a furnace or steam jacket known in the art may be used. To generate heat internally, a mixing device such as a rod, paddle or the like may be placed in the mixture. By stirring at high speeds, the paddle may generate heat from friction between the paddle and the material. This friction may be great enough that the heat generated from the friction may melt the sulfur.

For the elemental sulfur to be maintained in a molten state, the electrolyte precursor slurry may be heated to a temperature of above 100° C. For example, the elemental sulfur may be heated to a temperature of 100° C. or greater, 105° C. or greater, 110° C. or greater, 115° C. or greater, 120° C. or greater, 125° C. or greater, 130° C. or greater, 135° C. or greater, 140° C. or greater, 145° C. or greater, or 150° C. or greater. As another example, the electrolyte precursor slurry may be heated to a temperature from about 100° C. to about 115° C., about 100° C. to about 120° C., about 100° C. to about 140° C., about 100° C. to about 150° C., about 100° C. to about 160° C., about 100° C. to about 180° C., about 100° C. to about 200° C., about 100° C. to about 220° C., about 100° C. to about 240° C., about 100° C. to about 260° C., about 100° C. to about 280° C., about 100° C. to about 300° C., about 115° C. to about 300° C., about 120° C. to about 300° C., about 140° C. to about 300° C., about 150° C. to about 300° C., about 160° C. to about 300° C., about 180° C. to about 300° C., about 200° C. to about 300° C., about 220° C. to about 300° C., about 240° C. to about 300° C., about 260° C. to about 300° C., about 280° C. to about 300° C., about 115° C. to about 120° C., about 120° C. to about 140° C., about 140° C. to about 150° C., about 150° C. to about 160° C., about 160° C. to about 180° C., about 180° C. to about 200° C., about 200° C. to about 220° C., about 220° C. to about 240° C., about 240° C. to about 260° C., or about 260° C. to about 280° C.

In some embodiments, heating the elemental sulfur to a temperature from about 115° C. to about 150° C. may cause the molten sulfur to be in a low viscosity state, which may possess the optimal rheology characteristics for forming a homogenous slurry. In another embodiment, heating the elemental sulfur to a temperature from about 115° C. to about 150° C. may produce optimal rheological conditions for milling the solid electrolyte precursor due to an optimized balance between the liquid phase temperature and the evaporation rate. In yet another embodiment heating the elemental sulfur to temperatures greater than 150° C., such as from about 150° C. to about 300° C., may produce optimal rheological conditions for grinding the solid electrolyte precursor due to an optimized balance between temperature of the liquid phase and the evaporation rate, particularly when elevated pressure is maintained as explained further below.

When using temperatures above the melting point of the elemental sulfur, some sulfur may be in a vapor phase in addition to the liquid phase. To prevent sulfur from leaving the system, a closed vessel may be used during the contacting. The vessel may be pressurized. Alternatively, the vessel may be only partially closed to allow for a buildup of pressure while simultaneously allowing a small amount of sulfur vapor and other gases to leave the vessel. In one embodiment, the vessel may include a condenser to allow for the capture of the sulfur vapor for reuse.

The elemental sulfur may be heated to a molten state before adding the one or more solid electrolyte precursors to form the electrolyte precursor slurry. Alternatively, the one or more solid electrolyte precursors and elemental sulfur may be combined first. This mixture may then be heated such that the sulfur becomes molten, at which point, agitation such as mixing, stirring, griding, milling, high energy shearing, or a combination thereof may be employed. When contacting the solid electrolyte precursor with elemental sulfur, some of the sulfur may be in a solid state, gaseous state, or combination thereof.

The molten elemental sulfur and the solid electrolyte precursor may be combined in a volume ratio from about 1:99 to about 99:1. For example, the molten elemental sulfur and the at least one electrolyte precursor may be combined in a volume ratio from about 1:99 to about 1:75, about 1:99 to about 1:50, about 1:99 to about 1:25, about 1:99 to about 1:10, about 1:99 to about 1:5, about 1:99 to about 1:1, about 1:99 to about 5:1, about 1:99 to about 10:1, about 1:99 to about 25:1, about 1:99 to about 50:1, about 1:99 to about 75:1, about 1:99 to about 99:1, about 1:75 to about 99:1, about 1:50 to about 99:1, about 1:25 to about 99:1, about 1:10 to about 99:1, about 1:5 to about 99:1, about 1:1 to about 99:1, about 5:1 to about 99:1, about 10:1 to about 99:1, about 25:1 to about 99:1, about 50:1 to about 99:1, about 75:1 to about 99:1, about 1:75 to about 75:1, about 1:50 to about 50:1, about 1:25 to about 25:1, about 1:10 to about 10:1, or about 1:5 to about 5:1. As another example, the molten elemental sulfur and the at least one electrolyte precursor may be combined in a volume ratio of about 1:99, 1:90, 1:80, 1:70, 1:60, 1:50, 1:40, 1:30, 1:20, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 20:1, 30:1, 40:1, 50:1, 60:1, 70:1, 80:1, 90:1, or about 99:1.

The molten elemental sulfur and the solid electrolyte precursor may be combined such that the molten elemental sulfur is present in an amount from about 10 wt % to 75 wt % of the combined mass of the molten elemental sulfur and the solid electrolyte precursor. For example, the molten elemental sulfur may be present in an amount from about 10 wt % to about 15 wt %, about 10 wt % to about 20 wt %, about 10 wt % to about 25 wt %, about 10 wt % to about 30 wt %, about 10 wt % to about 35 wt %, about 10 wt % to about 40 wt %, about 10 wt % to about 45 wt %, about 10 wt % to about 50 wt %, about 10 wt % to about 55 wt %, about 10 wt % to about 60 wt %, about 10 wt % to about 65 wt %, about 10 wt % to about 70 wt %, about 10 wt % to about 75 wt %, about 15 wt % to about 75 wt %, about 20 wt % to about 75 wt %, about 25 wt % to about 75 wt %, about 30 wt % to about 75 wt %, about 35 wt % to about 75 wt %, about 40 wt % to about 75 wt %, about 45 wt % to about 75 wt %, about 50 wt % to about 75 wt %, about 55 wt % to about 75 wt %, about 60 wt % to about 75 wt %, about 65 wt % to about 75 wt %, about 70 wt % to about 75 wt %, about 15 wt % to about 20 wt %, about 20 wt % to about 25 wt %, about 25 wt % to about 30 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt % about 65 wt % to about 70 wt %, or about 70 wt % to about 75 wt % of the combined mass of the molten elemental sulfur and the solid electrolyte precursor. As another example, the molten elemental sulfur may be present in an amount of about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, or about 75 wt % of the combined mass of the molten elemental sulfur and the solid electrolyte precursor.

The one or more solid electrolyte precursors may be combined with the molten sulfur for a period of time long enough for one or more of the solid electrolyte precursors to have a reduction in its level of crystallinity, particle size, or a change in phase such as a crystalline phase or an amorphous phase. Such changes represent an interaction between the solid electrolyte precursor and the molten sulfur which may be understood as dissolution, combination, alloying, or a combination thereof. In some embodiments, the one or more solid electrolyte precursors may be combined with the molten sulfur for a period of time long enough for one of more of the above properties change. Nonlimiting examples of this period of time may be greater than 1 minute, greater than 10 minutes, greater than 20 minutes, greater than 30 minutes, greater than 45 minutes, greater than 1 hour, greater than 2 hours, greater than 4 hours, greater than 8 hours, or greater than 12 hours. In some embodiments, the solid electrolyte precursor may be combined with the molten elemental sulfur for a period of time from about 15 minutes to about 36 hours, such as about 15 minutes to about 30 minutes, about 15 minutes to about 1 hour, about 15 minutes to about 2 hours, about 15 minutes to about 4 hours, about 15 minutes to about 8 hours, about 15 minutes to about 12 hours, about 15 minutes to about 24 hours, about 15 minutes to about 36 hours, about 30 minutes to about 36 hours, about 1 hour to about 36 hours, about 2 hours to about 36 hours, about 4 hours to about 36 hours, about 8 hours to about 36 hours, about 12 hours to about 36 hours, or about 24 hours to about 36 hours.

During step 102, the contacting of the solid electrolyte precursor and molten elemental sulfur may form a sulfide-based solid composite. This sulfide-based solid composite may contain at least one solid electrolyte. The at least one solid electrolyte may be crystalline, amorphous, or a combination thereof.

As depicted at step 104 of FIG. 1, the process 100 may further include separating the molten elemental sulfur from the sulfide-based solid composite. In some embodiments, the molten elemental sulfur may be separated from the sulfide-based solid composite such that at least 90% of the elemental sulfur may be removed from the sulfide-based solid composite. For example, at least 90%, at least 91%, at least 92%, at least 93%, at least 94%, at least 95%, at least 96%, at least 97%, at least 98%, at least 99%, or 100% of the elemental sulfur may be removed from the sulfide-based solid composite. As another example, about 90% to about 91%, about 90% to about 92%, about 90% to about 93%, about 90% to about 94%, about 90% to about 95%, about 90% to about 96%, about 90% to about 97%, about 90% to about 98%, about 90% to about 99%, about 90% to about 100%, about 91% to about 100%, about 92% to about 100%, about 93% to about 100%, about 94% to about 100%, about 95% to about 100%, about 96% to about 100%, about 97% to about 100%, about 98% to about 100%, about 99% to about 100%, about 91% to about 92%, about 92% to about 93%, about 93% to about 94%, about 94% to about 95%, about 95% to about 96%, about 96% to about 97%, about 97% to about 98%, or about 98% to about 99% of the elemental sulfur may be removed from the sulfide-based composite. The molten elemental sulfur may be separated from the sulfide-based solid material composite by evaporation, centrifuge, filtration, other techniques known in the art, or a combination thereof.

As depicted at step 106 of FIG. 1, the processes 100 may further include heating the sulfide-based solid composite to produce a sulfide-based solid electrolyte. The sulfide-based solid composite may be heated at a temperature from about 200° C. to about 700° C. For example, the sulfide-based solid composite may be heated at a temperature from about 200° C. to about 250° C., about 200° C. to about 300° C., about 200° C. to about 350° C., about 200° C. to about 400° C., about 200° C. to about 450° C., about 200° C. to about 500° C., about 200° C. to about 550° C., about 200° C. to about 600° C., about 200° C. to about 650° C., about 200° C. to about 700° C., about 250° C. to about 700° C., about 300° C. to about 700° C., about 350° C. to about 700° C., about 400° C. to about 700° C., about 450° C. to about 700° C., about 500° C. to about 700° C., about 550° C. to about 700° C., about 600° C. to about 700° C., about 650° C. to about 700° C., about 200° C. to about 300° C., about 300° C. to about 400° C., about 400° C. to about 500° C., or about 500° C. to about 600° C. As another example, the sulfide-based solid composite may be heated at a temperature of about 200° C., about 250° C., about 300° C., about 350° C., about 400° C., about 450° C., about 500° C., about 550° C., about 600° C., about 650° C., or about 700° C.

The sulfide-based solid composite may be heated for a duration from about 1 minute to about 36 hours. For example, the sulfide-based solid material composite may be heated for a period of time from about 1 minute to about 15 minutes, about 1 minute to about 30 minutes, about 1 minute to about 1 hour, about 1 minute to about 2 hours, about 1 minute to about 4 hours, about 1 minute to about 8 hours, about 1 minute to about 12 hours, about 1 minute to about 24 hours, about 1 minute to about 36 hours, about 15 minutes to about 36 hours, about 30 minutes to about 36 hours, about 1 hour to about 36 hours, about 2 hours to about 36 hours, about 4 hours to about 36 hours, about 8 hours to about 36 hours, about 12 hours to about 36 hours, or about 24 hours to about 36 hours. As another example the sulfide-based solid material composite may be heated for a duration of about 1 minute, about 15 minutes, about 30 minutes, about 1 hour, about 2 hours, about 3 hours, about 4 hours, about 5 hours, about 6 hours, about 7 hours, about 8 hours, about 9 hours, about 10 hours, about 12 hours, about 15 hours, about 18 hours, about 20 hours, about 24 hours, about 28 hours, about 32 hours, or about 36 hours.

The sulfide-based solid composite may be heated in an inert atmosphere which may be a vacuum, or a vessel filled with an inert gas such as nitrogen or argon. The inert gas may be static or flowing. In one embodiment, the sulfide-based solid material composite may be heated in a sulfur rich atmosphere where the sulfur may be in the form of elemental sulfur vapor.

The sulfide-based solid electrolyte resulting from the crystallization process may have a carbon content of 1 wt % or less. For example, the sulfide-based solid electrolyte may have a carbon content of about 1 wt % or less, about 0.5 wt % or less, about 0.01 wt % or less, or about 0.001 wt % or less. In some embodiments, the sulfide-based solid electrolyte may be free of carbon.

The sulfide-based solid electrolyte particles may each have a surface that contains less than about 0.5 wt % carbon. For example, the surface of the sulfide-based solid electrolyte particles may each have a surface that contains less than about 0.5 wt % carbon, less than about 0.1 wt % carbon, less than about 0.01 wt % carbon, or less than about 0.001 wt % carbon. In some embodiments, the surface of the sulfide-based solid electrolyte may be free of carbon.

The sulfide-based solid electrolyte may have a crystalline structure. For example, the sulfide-based solid electrolyte may have an X-ray diffraction pattern having peaks corresponding to a 2-theta of 17.5°±0.5°, 18.1°±0.5°, 19.9°±0.5°, 22.8°±0.5°, 25.95°±0.5°, 29.1°±0.5°, 29.9°±0.5°, and 31.1°±0.5° with Cu—Kα(1,2)=1.541 Å. In another example, the sulfide-based solid electrolyte may have an amorphous structure. In yet another example, the sulfide-based solid electrolyte may have a combination of a crystalline structure and an amorphous structure.

The sulfide-based solid electrolyte may have the formula Li_{(7-y-z)}PS_{(6-y-z)}X_{y}W_{z}, wherein X and W are individually selected from F, Cl, Br, and I; 0≤y≤2; 0≤z≤2; and wherein 0≤y+z≤2. In a further embodiment, the sulfide-based solid electrolyte may have the formula Li⁺_{(12-n-w)}Bⁿ⁺X²⁻_{6-w}Y^{-x} _{w}, wherein Bⁿ⁺ is P, As, Ge, Ga, Sb, Si, Sn, Al, In, Ti, V, Nb, or Ta; X²⁻ is S, Se, or Te; Y⁻ is Cl, Br, I, F, BH₄, BF₄, CN, OCN, SCN, or N₃; wherein x is any number from about 0 to about 1; wherein n is any number from about 3 to about 5; and wherein w is any number from about 0 to about 2. In some embodiments, the sulfide-based solid electrolyte may include Li-₂P₂S₆, Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, Li₅PS₄ClBr, or any combination thereof.

The resulting sulfide-based solid electrolyte may have a particle size distribution (PSD) with a D50 of greater than about 30 μm. For example, the resulting sulfide-based solid electrolyte may have a PSD with a D50 of about 30 μm or greater, about 35 μm or greater, about 40 μm or greater, about 45 μm or greater, about 50 μm or greater, about 55 μm or greater, about 60 μm or greater, about 65 μm or greater, or about 70 μm or greater. As another example, the resulting sulfide-based solid electrolyte may have a PSD with a D50 from about 30 μm to about 40 μm, about 30 μm to about 50 μm, about 30 μm to about 60 μm, about 30 μm to about 70 μm, about 40 μm to about 50 μm, about 40 μm to about 60 μm, about 40 μm to about 70 μm, about 50 μm to about 60 μm, about 50 μm to about 70 μm, or about 60 μm to about 70 μm. As another example, the resulting sulfide-based solid electrolyte may have a PSD with a D50 of about 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, or about 70 μm. In an example, the resulting sulfide-based solid electrolyte may have a PSD with a D50 of 50 μm or greater,

In another embodiment, the resulting sulfide-based solid electrolyte may have a PSD with a D50 from about 0.5 μm to about 500 μm. For example, the resulting sulfide-based solid electrolyte may have a PSD with a D50 from about 0.5 μm to about 1 μm, about 0.5 μm to about 2 μm, about 0.5 μm to about 5 μm, about 0.5 μm to about 10 μm, about 0.5 μm to about 15 μm, about 0.5 μm to about 20 μm, about 0.5 μm to about 25 μm, about 0.5 to about 30 μm, about 0.5 μm to about 50 μm, about 0.5 μm to about 75 μm, about 0.5 μm to about 100 μm, about 0.5 μm to about 150 μm, about 0.5 μm to about 200 μm, about 0.5 μm to about 250 μm, about 0.5 μm to about 300 μm, about 0.5 μm to about 350 μm, about 0.5 μm to about 400 μm, about 0.5 μm to about 450 μm, about 0.5 μm to about 500 μm, about 1 μm to about 500 μm, about 2 μm to about 500 μm, about 5 μm to about 500 μm, about 10 μm to about 500 μm, about 15 μm to about 500 μm, about 20 μm to about 500 μm, about 25 μm to about 500 μm, about 30 μm to about 500 μm, about 50 μm to about 500 μm, about 75 μm to about 500 μm, about 100 μm to about 500 μm, about 150 μm to about 500 μm, about 200 μm to about 500 μm, about 250 μm to about 500 μm, about 300 μm to about 500 μm, about 350 μm to about 500 μm, about 400 μm to about 500 μm, about 450 μm to about 500 μm, about 1 μm to about 2 μm, about 2 μm to about 5 μm, about 5 to about 10 μm, about 10 μm to about 15 μm, about 15 μm to about 20 μm, about 20 μm to about 30 μm, about 30 μm to about 50 μm, about 50 μm to about 75 μm, about 75 μm to about 100 μm, about 100 μm, to about 150 μm, about 150 μm to about 200 μm, about 200 μm to about 250 μm, about 250 μm to about 300 μm, about 300 μm to about 350 μm, about 350 μm to about 400 μm, about 400 to about 450 μm, or about 450 μm to about 500 μm. As another example, the resulting sulfide-based solid electrolyte may have a PSD with a D50 of about 0.5 μm, about 1 μm, about 2 μm, about 5 μm, about 10 μm, about 15 μm, about 20 μm, about 30 μm, about 50 μm, about 75 μm, about 100 μm, about 150 μm, about 200 μm, about 250 μm, about 300 μm, about 350 μm, about 400 μm, about 450 μm, or about 500 μm.

The resulting sulfide-based solid electrolyte may have a surface area of about 5 m²/g or less. For example, the resulting sulfide-based solid electrolyte may have a surface area of about 5 m²/g or less, about 4 m²/g or less, about 3 m²/g or less, about 2 m²/g or less, about 1 m²/g or less, or about 0.5 m² /g or less. As another example, the resulting sulfide-based solid electrolyte may have a surface area from about 0.5 m²/g to about 1 m²/g, about 0.5 m²/g to about 2 m²/g, about 0.5 m²/g to about 3 m²/g, about 0.5 m²/g to about 4 m²/g, about 0.5 m²/g to about 5 m²/g, about 1 m²/g to about 2 m²/g, about 1 m²/g to about 3 m²/g, about 1 m²/g to about 4 m²/g, about 1 m²/g to about 5 m²/g, about 2 m²/g to about 3 m²/g, about 2 m²/g to about 4 m²/g, about 2 m²/g to about 5 m²/g, about 3 m² /g to about 4 m²/g, about 3 m²/g to about 5 m²/g, or about 4 m²/g to about 5 m²/g. As another example, the resulting sulfide-based solid electrolyte may have a surface area of about 0.5 m² /g, 0.6 m²/g, 0.7 m²/g, 0.8 m²/g, 0.9 m²/g, 1 m²/g, 1.25 m²/g, 1.5 m²/g, 1.75 m²/g, 2 m²/g, 2.25 m²/g, 2.5 m² /g, 2.75 m²/g, 3 m²/g, 3.25 m²/g, 3.5 m²/g, 3.75 m²/g, 4 m²/g, 4.25 m²/g, 4.5 m²/g, 4.75 m²/g, or about 5 m²/g. In an example, the surface area of the resulting sulfide-based solid electrolyte may be less than 2 m²/g.

The disclosed process 100 may be performed as a batch process. The batch process may include adding a specified amount of at least one solid electrolyte precursors and elemental sulfur to a vessel to allow for mixing and/or milling of the solid electrolyte precursors to occur in molten sulfur. Next, the sulfur may be removed, and the resulting sulfide-based solid electrolyte material may be further heat treated.

Alternatively, the process 100 may be performed as a continuous process. The continuous process may include contacting the at least one solid electrolyte precursors and molten sulfur in a holding tank to form the electrolyte precursor slurry. The electrolyte precursor slurry may then be pumped through a mixing apparatus. The electrolyte precursor slurry may pass through the mixing apparatus one or more times. In some embodiments, the electrolyte precursor slurry may repeatedly pass through the mixing apparatus until the electrolyte precursors are converted into a sulfide-based solid composite. In one example of the continuous process, the entire system may be heated to a temperature at or above the melting point of elemental sulfur. After the sulfide-based solid composite is formed, the molten elemental sulfur may be separated from the sulfide-based solid electrolyte material and the molten elemental sulfur may be recycled back into the continuous process.

Further provided herein are solid-state batteries that include the sulfide-based solid electrolyte described herein. The solid-state battery includes electrochemical cell layers including an anode layer, a separator layer, and a cathode layer. The sulfide-based solid electrolyte may be included in the anode layer, the separator layer, the cathode layer, or any combination thereof.

The solid-state battery may further comprise an oxide, oxysulfide, sulfide, halide, nitride, or any other solid electrolyte known in the art in one or more of the electrochemical cell layers. In some preferred embodiments, the solid electrolyte may comprise a sulfide solid electrolyte material, i.e., a solid electrolyte having at least one sulfur component. In some embodiments, the solid electrolyte may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). Halide solid electrolytes may have the structure Li-M-X, M is a metal element, and X is a halogen. These can be expressed by the generic formula Li_{α}M⁴⁺_{β}A³⁺_{(1-β)}X_{Ω}Y_{(6-Ω)}, where: 0≤β≤1; 0≤Ω≤6; α=6−[(β*4)+(1−β)*3]; X and Y are each independently a halogen such as F, Cl, Br, I; M is an element having an oxidation state of 4+ such as Ti, Zr, Hf, and Rf; and A is an element having an oxidation state of 3+ such as Ga, In, and Tl, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In another embodiment, the sulfide-based solid electrolyte may include of Li₃PS₄, Li₄P₂S₆, Li₇P₃S₁₁, Li₁₀GeP₂S₁₂, or Li₁₀SnP₂S₁₂. In a further embodiment, the solid electrolyte material may include Li₆PS₅Cl, Li₆PS₅Br, Li₆PS₅I, or may be expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the sulfide-based solid electrolyte be expressed by the formula Li_{8-y-z}P₂S_{9-y-z}X_{y}W_{z} where X and W each independently represent at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The electrochemical cell layer may include a solid electrolyte in an amount from about 30% to about 99% by weight of the electrochemical cell layer. In some aspects, the solid electrolyte material may be present in the electrochemical cell layer in an amount from about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 99%, about 40% to about 99%, about 45% to about 99%, about 50% to about 99%, about 55% to about 99%, about 60% to about 99%, about 65% to about 99%, about 70% to about 99%, about 75% to about 99%, about 80% to about 99%, about 85% to about 99%, about 90% to about 99%, about 40% to about 90%, about 40% to about 80%, about 40% to about 70%, about 40% to about 60%, about 40% to about 55%, about 40% to about 50%, or about 40% to about 45% by weight of the electrochemical cell layer.

When the electrochemical cell layer is a separator layer, the electrochemical cell layer may include a solid electrolyte material in an amount from about 60% to about 99% by weight of the separator layer. In some aspects, the solid electrolyte may be present in the electrochemical cell layer in an amount from about 60% to about 65%, about 60% to about 70%, about 60% to about 75%, about 60% to about 80%, about 60% to about 85%, about 60% to about 90%, about 60% to about 95%, about 60% to about 99%, about 65% to about 99%, about 70% to about 99%, about 75% to about 99%, about 80% to about 99%, about 85% to about 99%, about 90% to about 99%, or about 70% to about 90% by weight of the separator layer.

The electrochemical cell layer may comprise a binder where the binder may be one or more of a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly (vinylene difluoride-hexafluoropropylene) copolymer (PVDF-HFP), and the like. In another embodiment, the binder may include a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may include an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may include a polycondensation polymer such as but not limited to polyurea, polyamide paper, polyimide, polyester, and the like. In yet a further embodiment, the binder may include a nitrile rubber such as but not limited to acrylonitrile-butadiene rubber (ABR), polystyrene nitrile-butadiene rubber (PS-NBR), and mixtures thereof.

Preferably, the binder comprises a thermoplastic elastomer such as those comprising styrene and butadiene. For example, the binder may comprise styrene-butadiene-styrene copolymer (SBS), styrene-isoprene block copolymer (SIS), styrene-ethylene-butylene-styrene (SEBS), or combinations thereof.

The binder may be present in the electrochemical cell layer in an amount from about 1% to about 30% by weight of the electrochemical cell layer. For example, the binder may be present in the electrochemical cell layer in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, about 25% to about 30%, about 5% to about 15%, about 5% to about 20%, about 10% to about 15%, about 10% to about 20%, or about 15% to about 20% by weight of the electrochemical cell layer.

The electrochemical cell layer may further comprise a conductive additive where the conductive additive may include metal powders, fibers, filaments, or any other material known to conduct electrons. The conductive additive may comprise a carbon-based conductive additive, such as carbon fiber, graphite, graphene, carbon black, conductive carbon, amorphous carbon, vapor grown carbon fiber (VGCF), carbon nanotubes, carbon nanowires, activated carbon, and combinations thereof.

The conductive additive may be present in the electrochemical cell layer in an amount from about 0% to about 15% by weight of the electrochemical cell layer. In some aspects, the conductive additive may be present in the electrochemical cell layer in an amount from about 0% to about 10%, or about 0% to about 5% by weight of the electrochemical cell layer. In some additional aspects, the conductive additive may be present in the electrochemical cell layer in an amount of about 0%, 1%, 2%, 3%, 4%, 5%, 6%, 7%, 8%, 9%, 10%,11%, 12%, 13%, 14%, or about 15% by weight of the electrochemical cell layer. In an example embodiment, the conductive additive is present in the electrochemical cell layer in an amount from about 0% to about 5% by weight of the electrochemical cell layer.

In some embodiments, the average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the conductive additive may have an average particle size of about 30 nm. The average particle size (e.g., D50) may be determined through any method known to those having ordinary skill in the art, for example, by a particle size analyzer or a transmission electron microscope photograph or a scanning electron microscope photograph. Alternatively, the size may be measured using a dynamic light scattering method, and data analysis may be performed to count the number of particles with respect to each particle size range, and then calculated therefrom to obtain an average particle diameter value. Unless otherwise specified, the average particle diameter may be measured by a particle size analyzer, and refers to a diameter (D50) of particles having a cumulative volume of 50 vol % in a particle size distribution.

In some embodiments, the electrochemical cell layer may comprise an anode active material. The anode active material preferably is an inorganic material. The anode active material may comprise one or more inorganic materials such as silicon (Si), silicon alloys, tin (Sn), tin alloys, germanium (Ge), germanium alloys, graphite, Li₄Ti₅O₁₂ (LTO) or other known anode active materials and combinations thereof.

The anode active material may be present in the electrochemical cell layer in an amount from about 30% to about 98% by weight of the electrochemical cell layer. In some aspects, the anode active material may be present in the electrochemical cell layer in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight of the electrochemical cell layer.

In some embodiments, the electrochemical cell layer may comprise a cathode active material. The cathode active material may include nickel-manganese-cobalt (“NMC”) which can be expressed as Li(NiₐCo_{b}Mn_{c})O₂(0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material may include a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂ (0≤Y<1), Li(NiₐCo_{b}Mn_{c})O₄(0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LiFePO₄, CuO, Li(NiₐCo_{b}Al_{c})O₂ (0<a<1, 0<b<1, 0<c<1, a+b+c=1) or a combination thereof. In yet another embodiment, the cathode active material may include a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combinations thereof. In still further embodiments, the cathode active material may comprise elemental sulfur (S). In additional embodiments, the cathode active material may include a fluoride cathode active material such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or combinations thereof.

The cathode active material may be present in the electrochemical cell layer in an amount from about 30% to about 98% by weight of the electrochemical cell layer. In some aspects, the cathode active material may be present in the electrochemical cell layer in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight of the electrochemical cell layer.

### EXAMPLES

### Example 1: Heating to 150° C.

A solid electrolyte precursor composite was formed by mixing an amount of Li₂S, P₂S₅, and LiCl in a molar ratio of 5:1:2 (Li₂S:P₂S₅:LiCl). 0.250 g of this solid electrolyte precursor composite was mixed with 0.250 g of elemental sulfur. An aliquot of this mixture was placed in a semi-sealed ampule and heated to 150° C. for 1 hour, resulting in the material of Example 1. In Example 1, the density of the electrolyte precursor composite containing Li₂S, P₂S₅, and LiCl in a molar ratio of 5:1:2 (Li₂S:P₂S₅:LiCl) was approximately 1.64 g/mL. The volume of the 0.250 g of electrolyte precursor composite used in Example 1 was approximately 0.152 mL. The density of the sulfur used in Example 1 was approximately 2 g/mL. The volume of sulfur used in Example 1 was approximately 0.125 mL. The volume ratio of elemental sulfur to electrolyte precursors was 0.82:1 or 45 vol % elemental sulfur to 55 v % electrolyte precursors.

### Example 2: Heating to 250° C.

An aliquot of the material of Example 1 was placed in a semi-sealed ampule and heated to 250° C. for 1 hour, resulting in the material of Example 2 Analysis

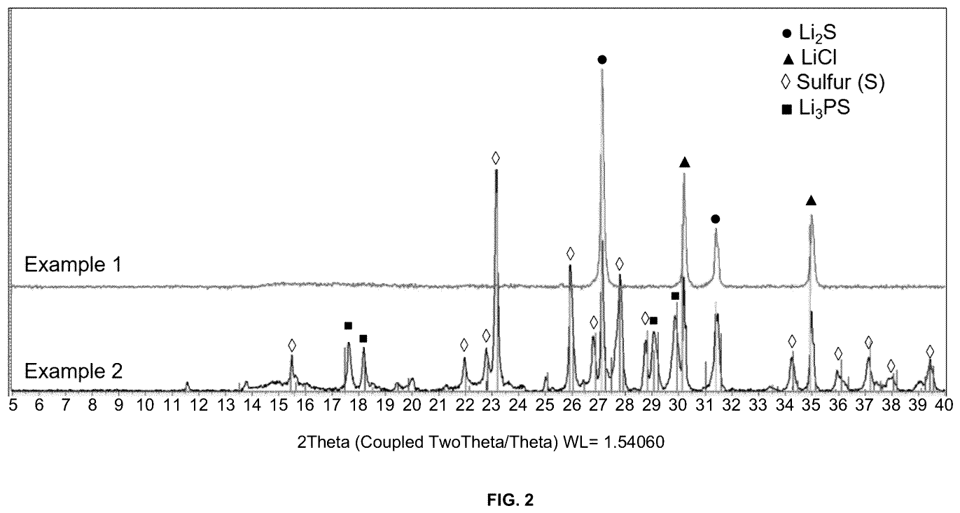

From the XRD pattern of Example 1 in FIG. 2, it can be seen that by contacting P₂S₅ with molten sulfur, the P₂S₅ and Sulfur were rendered amorphous as compared to their normal crystalline forms.

From the XRD pattern of Example 2 in FIG. 2, it can be seen that by contacting solid electrolyte precursor materials with sulfur at a temperature above its melting point, 250° C., an electrolyte material was formed. This was confirmed by the presence of the Li₃PS₄ electrolyte phase.

What is claimed is:

1. A process for making a sulfide-based solid composite including a sulfide-based solid electrolyte, comprising:
contacting a solid electrolyte precursor with molten elemental sulfur at a temperature of about 100° C. or greater to form a sulfide-based solid composite.

2. The process of claim 1, wherein the contacting comprises mixing the solid electrolyte precursor with the molten elemental sulfur.

3. The process of claim 1, wherein the contacting comprises milling the solid electrolyte precursor with the molten elemental sulfur.

4. The process of claim 1, wherein the solid electrolyte precursor comprises lithium, phosphorus, sulfur, or a combination thereof.

5. The process of claim 1, wherein the solid electrolyte precursor comprises lithium metal, Li₂S, Li₂SO₄, LiOH, Li₂CO₃, or a combination thereof.

6. The process of claim 1, wherein the solid electrolyte precursor comprises elemental phosphorous, P₄S₁₀ (P₂S₅), P₄S₉, P₄S₇, P₄S₃, P₄Sₓ wherein X>10, or a combination thereof.

7. The process of claim 1, wherein the solid electrolyte precursor comprises Na₂Sₓ, K₂Sₓ, Li₂Sₓ wherein 1≤X≤8, NaSH, LiSH, or a combination thereof.

8. The process of claim 1, wherein the solid electrolyte precursor comprises LiF, LiCl, LiBr, LiI, LiClₓBr_{y} wherein 0<x<1, 0<y<1, and x+y=1, or a combination thereof.

9. The process of claim 1, wherein the solid electrolyte precursor comprises a halogen-containing material comprising F, Cl, Br, I, or a combination thereof.

10. The process of claim 1, wherein the contacting occurs at a temperature from about 100° C. to about 300° C.

11. The process of claim 1, wherein the contacting occurs for a period of time from about 1 minute to about 36 hours.

12. The process of claim 1, further comprising separating at least 90% of the elemental sulfur from the sulfide-based solid composite by evaporation, filtration, centrifuge, or a combination thereof.

13. The process of claim 1, further comprising heating the sulfide-based solid composite to a temperature greater than about 300° C.

14. The process of claim 1, wherein the sulfide-based solid composite is heated to a temperature greater than about 300° C. for a period of time from about 1 minute to about 36 hours to form a sulfide-based solid electrolyte.

15. The process of claim 14, wherein the sulfide-based solid electrolyte has the formula Li_{(7-y-z)}PS_{(6-y-z)}X_{y}W_{z}, wherein X and W are individually selected from F, Cl, Br, and I; 0≤y≤2; 0≤z≤2; and 0≤y+z≤2.

16. The process of claim 14, wherein the sulfide-based solid electrolyte has the formula Li₂P₂S₆, Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, or Li₅PS₄ClBr.

17. The process of claim 1, wherein the molten elemental sulfur is present in an amount from about 10 wt % to 75 wt % of the combined mass of the molten elemental sulfur and the solid electrolyte precursor.

18. A battery comprising the sulfide-based solid electrolyte of claim 1.

19. A sulfide-based solid electrolyte comprising lithium and sulfur having a particle size greater than about 0.5 μm produced by:
contacting a solid electrolyte precursor with molten elemental sulfur at a temperature greater from about 100° C. and to about 300° C. for a period of time from about 1 minute to about 36 hours to produce a sulfide-based solid composite;
separating at least 90% of the molten elemental sulfur from the sulfide-based solid composite; and
heating the sulfide-based solid composite to a temperature of greater than about 300° C. for a period of time from about 1 minute to about 36 hours.

20. The sulfide-based solid electrolyte of claim 19, wherein the sulfide-based solid electrolyte has a carbon content of about 1 wt % or less and a surface that contains less than about 0.5 wt % carbon.

21. The sulfide-based solid electrolyte of claim 19, comprising a solid electrolyte material having the formula Li_{(7-y-z)}PS_{(6-y-z)}X_{y}W_{z}, wherein X and W are individually selected from F, Cl, Br, and I; y and z each individually range from 0 to 2; and wherein y+z ranges from 0 to 2.

22. The sulfide-based solid electrolyte of claim 19, comprising a solid electrolyte material having the formula Li₂P₂S₆, Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, and Li₅PS₄ClBr.

23. The sulfide-based solid electrolyte of claim 19, comprising an X-ray diffraction pattern having peaks corresponding to a 2-theta of 17.5°±0.5°, 18.1°±0.5°, 19.9°±0.5°, 22.8°±0.5°, 25.95°±0.5°, 29.1°±0.5°, 29.9°±0.5°, and 31.1°±0.5° with Cu—Kα(1,2)=1.541 Å.

24. The sulfide-based solid electrolyte of claim 19, wherein the particle size is greater than about 20 μm.
